(19) United States
(12) Patent Application Publication
(10) Pub. No.: US 2016/0273486 A1
(43) Pub. Date: Sep. 22, 2016

(54) PISTON FOR AN INTERNAL COMBUSTION ENGINE AND METHOD FOR THE PRODUCTION THEREOF

(71) Applicant: MAHLE INTERNATIONAL GMBH, Stuttgart (DE)

(72) Inventor: Wolfgang ISSLER, Schwaikheim (DE)

(21) Appl. No.: 15/033,641

(22) PCT Filed: Oct. 28, 2014
(86) PCT No.: PCT/EP2014/002896

§ 371 Date: Apr. 30, 2016

(30) Foreign Application Priority Data
Oct. 30, 2013 (DE) 10 2013 018 250.6

(51) Int. Cl. F02F 3/22

(52) U.S. Cl. CPC F02F 3/22; F02F 2200/04

(57) ABSTRACT

A piston for an internal combustion engine, may include a piston crown and a piston skirt. The piston skirt may have mutually opposite pin bosses with boss bores, and mutually opposite skirt walls with running surfaces. The piston may also include a cover provided at a lower end of the piston. The cover may be molded onto free ends of the mutually opposite skirt walls in the form of base parts extending radially inward and formed integrally with the mutually opposite skirt walls.

### CROSS-REFERENCE TO RELATED APPLICATIONS

This application claims priority to German Patent Application No. 10 2013 018 250.6, filed Oct. 30, 2013, and International Patent Application No. PCT/EP2014/002896, filed Oct. 28, 2014, both of which are hereby incorporated by reference in their entirety.

### TECHNICAL FIELD

The present invention relates to a piston for an internal combustion engine, with a piston crown and a piston skirt, wherein the piston skirt has mutually opposite pin bosses with boss bores, and mutually opposite skirt walls with running surfaces, wherein a cover is provided at the lower end of the piston.

### BACKGROUND

A piston of the type in question is known from German laid-open specification DE 25 39 470 A1. The known piston has a collecting trough arranged at its lower end for cooling oil. During operation of the engine, the cooling oil is moved by the so-called “shaker effect”, which leads to an improved cooling effect. However, the collecting trough has to be securely and reliably fastened to the piston since it must not become detached during operation of the engine.

### SUMMARY

It is an object of the present invention to develop a piston of the type in question in such a manner that a cover provided at the lower end of the piston is fastened thereto securely and reliably and nevertheless in a technically straightforward manner. It is a further object of the present invention to provide a method for producing such a piston.

The achievement consists in that the cover is molded onto the free ends of the mutually opposite skirt walls in the form of base parts which extend radially inward and are formed integrally with the skirt walls.

In the method according to the invention, at least the piston skirt of the piston is produced by means of a forging process, in that skirt wall extensions are molded integrally onto the mutually opposite skirt walls by forging, and in that the skirt wall extensions are bent over radially inward such that radially inwardly extending base parts result.

The base parts provided according to the invention are connected integrally, i.e. non-detachably, to the piston, preferably by means of a forging process. This constitutes a technically straightforward method for producing the piston according to the invention.

The base parts provided according to the invention collect flowing-back cooling oil and delay the flowing away thereof in the direction of the crankshaft. The cooling oil can be conducted by means of an oil injection nozzle directly into the interior of the piston above the base parts or can flow out of a cooling duct, if present, into the interior of the piston. By means of the shaker effect which occurs during operation of the engine, the cooling oil which is collected by the base parts is moved to and fro at a high frequency in the direction of the boss bores and the piston crown. This results in an improved cooling effect.

It has been ascertained with measurements that the operating temperature of the piston crown, the annular grooves and the boss bores could be significantly reduced. In comparison to operating temperatures of 200° C. to 220° C. for pistons according to the prior art, the operating temperatures in the case of pistons according to the invention was reduced by up to 30%.

The base parts provided according to the invention furthermore permit improved cooling of the skirt walls since the collected cooling oil is accumulated in the region of the skirt walls and the improved cooling effect produced by the shaker effect occurs in intensified fashion in the region of the skirt walls.

The contour of the base parts can in principle be selected as desired and can be adapted to the interior shape of the piston. In order to obtain an optimally improved cooling effect, the base parts should, however, cover the largest possible region of the lower side of the piston. Care should merely be taken to ensure that sufficient space is available for the connecting rod movement during the operation of the engine.

The method according to the invention permits technically particularly straightforward production of the piston according to the invention. By means of a simple forging process, blanks having extended skirt walls are produced in a working process. The protruding region of the skirt walls is bent radially inward as a skirt wall extension by means of a simple bending process such that the base parts provided according to the invention result.

The base parts provided according to the invention can enclose a right angle or an acute angle with the skirt walls. In the latter case, a greater amount of cooling oil is collected, and therefore the cooling effect is further improved.

If the piston according to the invention is used in an engine with injection cooling, at least one base part expediently has a recess.

If the piston according to the invention is additionally provided with an encircling cooling duct with at least one supply opening for cooling oil, it is advantageous if the recess is formed in alignment with the at least one supply opening. In this case, the cooling duct can also be supplied with cooling oil by the oil injection nozzle.

At least one base part advantageously has at least one depression on its surface facing the piston interior, said depression acting as an oil collecting container, and therefore the cooling effect is intensified.

At least one bore or at least one radially running slot is preferably introduced between at least one skirt wall and the base part assigned thereto. Increased rigidity of the piston skirt can therefore be prevented, and therefore severe wearing or jamming of the piston skirt during operation of the engine is avoided.

A preferred development of the method according to the invention consists in that the base parts are provided on their lower surface facing away from the piston with at least one supporting surface for centering and securing the piston in a clamping tool. As a result, a possibly necessary final processing, in particular final machining, of the piston according to the invention is simplified.

The present invention is suitable in particular for pistons with a low compression height. These may be steel or light metal pistons with or without a cooling duct. A preferred field of use involves pistons made from an aluminum-based material without a cooling duct, as are described, for example, in German laid-open specification DE 41 10 306 A1.

An exemplary embodiment of the present invention is explained in more detail below with reference to the attached drawings. In a schematic illustration which is not true to scale:

### BRIEF DESCRIPTION OF THE DRAWINGS

FIG. 1 shows an exemplary embodiment of a piston according to the invention with skirt wall extensions bent over radially inward;

FIG. 2 shows a piston according to FIG. 1 in a view in the direction of the arrow A in FIG. 1;

FIG. 3 shows a blank for the piston according to FIG. 1 with axial skirt wall extensions.

### DETAILED DESCRIPTION

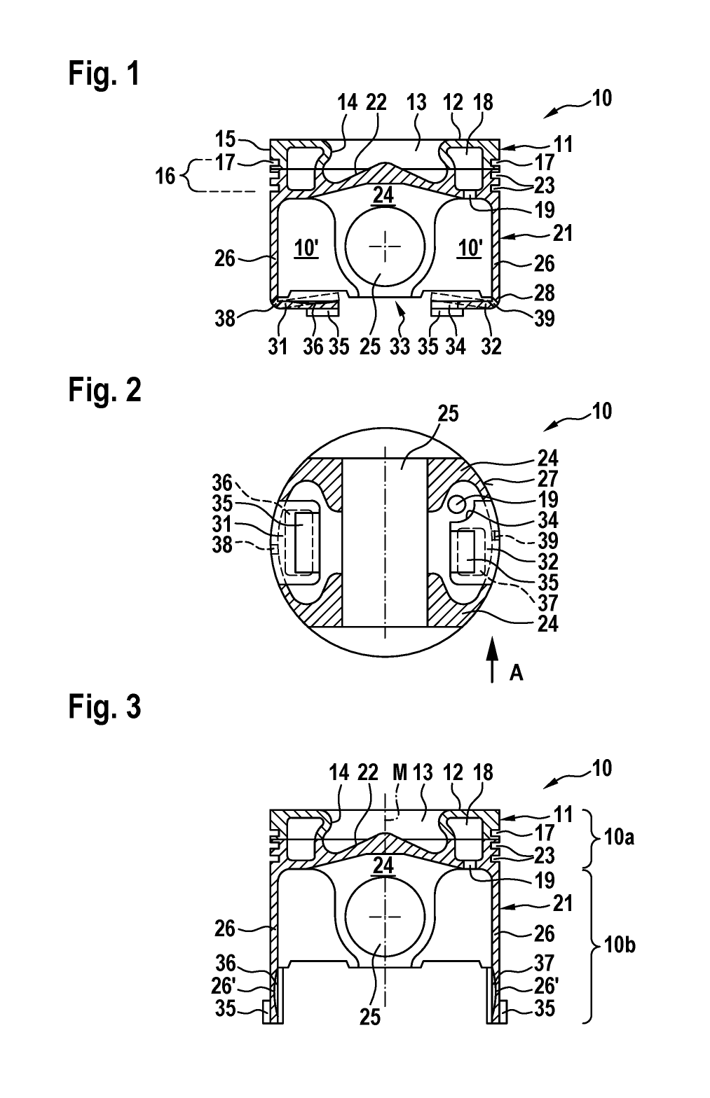

FIGS. 1 and 2 show an exemplary embodiment of a piston 10 according to the invention. The piston 10 can be produced from a steel material or a light metal material, in particular an aluminum-based alloy. The piston 10 preferably has a low compression height KH (for example KH/D=0.27 to 0.40) and can be formed with or without a cooling duct. In the exemplary embodiment, the piston 10 is a monobloc full slipper skirt piston composed of a piston crown element 11 and a main piston body 21, which are connected to each other non-detachably, for example by means of a welding process. The piston crown element 11 has a piston head 12, a wall region 14 of a combustion recess 13, an encircling fire land 15 and an uppermost annular groove 17 of an encircling annular portion 16. The main piston body 21 has a base region 22 of the combustion recess 13, the two lower annular grooves 23 of the annular portion 16 and mutually opposite piston bosses 24 with boss bores 25 for receiving a piston pin (not illustrated). The piston bosses 24 are connected to one another in a manner known per se via mutually opposite skirt walls 26 having running surfaces 27. The piston crown element 11 and the main piston body 21 together form an outer encircling cooling duct 18 which is arranged level with the annular portion 16 and has at least one supply opening 19 for cooling oil. The piston crown element 11 and the main piston body 21 together form the piston crown 10a of the piston 10, while the piston skirt 10b of the piston 10 is formed solely by the main piston body 21.

The piston 10 is provided in its lower region, i.e. approximately level with the lower edges 28 of its running surfaces 27, with two base parts 31, 32 which form a cover of the piston interior 10′. The base parts 31, 32 are molded integrally onto the free ends of the skirt walls 26, by means of a forging or bending process in the exemplary embodiment. The base parts 31, 32 extend radially inward in the direction of a piston center axis M and form a right angle with the skirt walls 26. However, the base parts 31, 32 may also be bent up in the direction of the piston interior 10′ such that they form an acute angle with the skirt walls 26, as indicated by dashed lines in FIG. 1. The contour of the base parts 31, 32 can be selected as desired. In order to achieve an optimally improved cooling effect, the base parts 31, 32 should, however, cover the greatest possible region of the lower side of the piston 10, wherein a sufficiently dimensioned passage opening 33 for a connecting rod has to be maintained.

If the piston 10 according to the invention is intended to be provided with injection cooling, a recess 34 which serves as a passage for a cooling oil jet emerging from an oil injection nozzle is provided in one of the base parts, in the base part 32 in the exemplary embodiment. In the exemplary embodiment, the recess 34 is arranged substantially in alignment with the supply opening 19 in the cooling duct 18 such that the latter can also be supplied with cooling oil.

The base parts 31, 32 provided according to the invention are connected integrally, i.e. non-detachably, to the piston and catch flowing-back cooling oil and delay the flowing away thereof in the direction of the crankshaft. By means of the shaker effect which occurs during operation of the engine, the cooling oil collected by the base parts 31, 32 is moved to and fro at a high frequency in the direction of the boss bores 25 and the piston crown 10a. This results in an improved cooling effect, in particular in the region of the skirt walls 26, since the collected cooling oil is accumulated in this region.

In the method according to the invention, at least the piston skirt 10b of the piston 10 is produced by means of a forging process. In the exemplary embodiment, the main piston body 21 is produced by means of a forging process. As can be gathered from FIG. 3, skirt wall extensions 26′ are molded integrally onto the skirt walls 26 during the forging. The forging method provided according to the invention also makes it possible to define the contour of the skirt wall extensions 26′ such that the passage opening 33 for the connecting rod and optionally the recess 34 for the entry of cooling oil are produced in the finished piston 10 without further processing steps.

Subsequently, the skirt wall extensions 26′ are bent over radially inward in the direction of the piston center axis M by means of a suitable bending process such that they form the radially inwardly extending base parts 31, 32 according to FIGS. 1 and 2 and the passage opening 33 and optionally the recess 34.

Before the bending of the base parts 31, 32, it is possible, for example during the forging or by means of a stamping process, for at least one depression 36, 37 to be introduced on the surface, which faces the piston interior, of one base part or of the two base parts 31, 32, said depression acting as an oil collecting container, and therefore the cooling effect is intensified.

Furthermore, after the bending of the base parts 31, 32, at least one supporting surface 35 can be introduced on the lower side, which faces away from the piston, of at least one of the base parts 31, 32 in order to provide a support of the piston 10 in a clamping device for further processing steps, in particular final machining of the piston 10. Said supporting surface 35 is removed again after the final processing of the piston 10. The supporting surface 35 can be introduced, for example, during the forging of the skirt wall extensions 26′ or after the bending by partial stamping of the base parts 31, 32, in particular during the production of the depressions 36, 37.

1. A piston for an internal combustion engine, comprising:
a piston crown;
a piston skirt having mutually opposite pin bosses with boss bores, and mutually opposite skirt walls with running surfaces; and
a cover provided at a lower end of the piston, the cover being molded onto free ends of the mutually opposite skirt walls in the form of base parts extending radially inward and formed integrally with the mutually opposite skirt walls.

2. The piston as claimed in claim 1, wherein the base parts are forged integrally with the mutually opposite skirt walls.

3. The piston as claimed in claim 1, wherein the base parts enclose form a right angle or an acute angle with the mutually opposite skirt walls.

4. The piston as claimed in claim 1, wherein at least one base part has a recess.

5. The piston as claimed in claim 4, wherein the piston crown has an encircling cooling duct with at least one supply opening for cooling oil, the at least one supply opening being in alignment with the recess.

6. The piston as claimed in claim 1, wherein at least one base part has at least one depression on a surface of the at least one base part facing an interior of the piston.

7. The piston as claimed in claim 1, wherein at least one skirt wall and a base part assigned thereto define at least one bore or at least one radially running slot therebetween.

8. A method for the production of a piston for an internal combustion engine comprising:
forging a piston skirt having mutually opposite pin bosses with boss bores, mutually opposite skirt walls with running surfaces, and skirt wall extensions molded integrally onto the mutually opposite skirt walls; and
bending over the skirt wall extensions radially inward such to form radially inwardly extending base parts.

9. The method as claimed in claim 8, wherein the base parts are each provided on their respective lower surfaces facing away from the piston with at least one supporting surface for centering and securing the piston in a clamping tool.

10. The method as claimed in claim 8, wherein the skirt wall extensions are bent such that the base parts form a right angle or an acute angle with the mutually opposite skirt walls.

11. The method as claimed in claim 8, wherein at least one base part has a recess.

12. The method as claimed in claim 11, wherein the recess is formed in alignment with at least one supply opening in an encircling cooling duct of a piston crown of the piston.

13. The method as claimed in claim 8, wherein at least one base part has at least one depression on a surface of the at least one base part facing an interior of the piston.

14. The method as claimed in claim 8, wherein at least one skirt wall and a base part assigned thereto define at least one bore or at least one radially running slot therebetween.

15. A piston for an internal combustion engine, comprising:
a piston crown;
a piston skirt having mutually opposite pin bosses with boss bores, and mutually opposite skirt walls with running surfaces; and
a cover provided at a lower end of the piston, the cover being molded onto free ends of the mutually opposite skirt walls in the form of base parts extending radially inward and formed integrally with the mutually opposite skirt walls at a right angle;
wherein the base parts cover the lower end of the piston, and define a passage opening for a connecting rod.

16. The piston as claimed in claim 15, wherein the base parts are forged integrally with the mutually opposite skirt walls.

17. The piston as claimed in claim 15, wherein at least one base part has a recess.

18. The piston as claimed in claim 17, wherein the piston crown has an encircling cooling duct with at least one supply opening for cooling oil, the at least one supply opening being in alignment with the recess.

19. The piston as claimed in claim 15, wherein at least one base part has at least one depression on a surface of the at least one base part facing an interior of the piston.

20. The piston as claimed in claim 15, wherein at least one skirt wall and a base part assigned thereto define at least one bore or at least one radially running slot therebetween.
